(19) United States
(12) Patent Application Publication
(10) Pub. No.: US 2008/0240513 A1
(43) Pub. Date: Oct. 2, 2008

(54) METHOD AND DEVICE FOR UPDATING MAP DATA

(75) Inventors: Jiecheng XIE, Beijing (CN); Chenghua XU, Beijing (CN); Min-Yu HSUEH, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (CHINA) CO., LTD., Beijing (CN)

(21) Appl. No.: 12/055,543

(22) Filed: Mar. 26, 2008

(30) Foreign Application Priority Data
Mar. 26, 2007 (CN) 200710088970.1

(51) Int. Cl. G06K 9/00; G06K 9/46; G06K 9/34

(52) U.S. Cl. 382/113; 382/192; 382/190; 382/209; 382/173

(57) ABSTRACT

Disclosed is a method and device for updating map data, wherein each site on the map being associated with geographic data and at least one scene image captured at the site, the method comprising: at each site, collecting video data and geographic data representing the position of the site; extracting a distinctive region from the scene image which represents the site on the basis of a predetermined criterion, and associating the distinctive region with the site; extracting from the video data at least one image which is captured at the site on the basis of the position of the site; matching the distinctive region and the extracted image to generate matching results; and updating the scene image using the image matched with the distinctive region as a updated image, in the case of the matching results indicating that the map data need to be updated. With the present invention, map data can be updated quickly so as to provide users with the latest geographic information.

### BACKGROUND OF THE INVENTION

1. Field of Invention

The present invention relates to geographic information processing technology, in particular to a method and device for quickly updating map data to provide users with the latest geographic information.

2. Description of Prior Art

Nowadays, the map is playing an important role in our daily life. The map tells people which route they can travel along in order to reach their destinations. The map can also notify travelers of other information on their destinations.

In addition to location information and names of business sites that the conventional map can tell, some new-types of maps, such as electronic map, can provide users with scenes along the routes to their destinations and around the destinations.

Regarding the electronic map, Patent document 1 (U.S. Pat. No. 6,640,187), for example, discloses a typical method for creating a geographic information database. According to this method, sensors are installed in vehicles so as to collect geographic information sensed by the sensors as the vehicles are driven along a road; then, an electronic map is created on the basis of the collected geographic information.

To make the electronic map more suitable for applications, it has been proposed that attached information, such as pictures, can be associated with geographic information to form a new map called composite map. When a user clicks on a site of interest on the map, live scene images captured at the site are displayed on a screen so that the user can determine whether the site is expected. As an example, if a user wants to learn whether there is any restaurant around some site, he/she can click on the site, and immediately the scene images captured at the site will be shown on the screen. In the way, the user can learn the environment about the site without actually arriving at the place.

Patent document 2 (U.S. Pat. No. 6,233,523), for example, reveals a method of collection and linking of positional data and other data, in which as a vehicle travels on a road, a satellite localization device installed in the vehicle provides and records the current position of the vehicle, with one or several cameras installed on the same vehicle taking pictures of buildings along the road. In the constructed database, data related to the postal addresses of individual buildings and their pictures are associated together. While using the map, a user can obtain pictures of a destination near the site of his/her interest after determination of the site.

Moreover, Patent document 3 (WO20051119630 A2) describes a system for generating map data, in which cameras are mounted on a vehicle and used to take pictures of certain sites as the vehicle travels. In constructing a map, geographic information on respective sites on the electronic map is associated with their image data to enrich the information intended for users.

These schemes mentioned above increase the types of information offered by the conventional map, and the provided multimedia information is useful to users. On the other hand, facilities in a city, such as streets and names of business sites, vary rapidly as time passes. Besides, names of some business facilities are changed due to the substitution of proprietors, which makes users unable to find the business facilities at real sites as indicated on the map. For example, even though a user arrives at a site which is clearly indicated on the map and labeled as a restaurant specialized in Hunan cuisine, the restaurant may have been taken over by a new owner, and the flavor of the restaurant may thus be changed into Guangdong cuisine. Indeed, the user must be upset. Therefore, it becomes important to update a map timely. The existing map updating methods depend on manual operation, however, which disables a quick update of electronic map.

Further, the current composite map only associates a site with scene images captured at the site. This leads to failure in providing user with personalized information and high accuracy of search operation.

### SUMMARY OF THE INVENTION

The present invention is made in view of the above problems. The object of the present invention is to provide a method and device capable of quickly updating map data so as to provide users with the latest geographic information.

According to one aspect of the present invention, a method for updating map data is provided, wherein each site on the map being associated with geographic data and at least one scene image captured at the site, the method comprising: at each site, collecting video data and geographic data representing the position of the site; extracting a distinctive region from the scene image which represents the site on the basis of a predetermined criterion, and associating the distinctive region with the site; extracting from the video data at least one image which is captured at the site on the basis of the position of the site; matching the distinctive region and the extracted image to generate matching results; and updating the scene image using the image matched with the distinctive region as a updated image, in the case of the matching results indicating that the map data need to be updated.

With this solution, the distinctive regions representing the individual sites from the scene images of the sites on the composite map are associated, and the distinctive regions, instead of the overall scene images, are matched with images from the captured video data. Therefore, the updating of map data is accelerated with an improved accuracy for matching operation.

Preferably, the method further comprises further associating the site with the distinctive region included in the updated image and canceling the association of the site with the distinctive region included in the scene image, in case of the matching results indicating that the map data need to be updated.

With the above solution, it is possible to refine the composite map in which each site is associated with both geographic data and scene image, since in the refined composite map each site is further associated with the distinctive region from the scene image. Obviously, more accurate information can be provided to users.

Preferably, the method further comprises segmenting the video data into video segments corresponding to streets.

With such solution, in updating map data, the update can be performed individually for each street so as to improve the manageability for the streets.

Preferably, the method further comprises: counting the number of sites where the distinctive regions are not matched with the scene image; and the step of updating is performed in case of the number exceeding a predetermined threshold.

With such solution, it is possible to avoid inconvenience and resource waste due to frequent update of map data.

Preferably, the step of extracting a distinctive region from the scene image which represents the site on the basis of a predetermined criterion comprises: localizing character information included in the scene image by using optical character recognition technique; and extracting the region occupied by the character information in the scene image as the distinctive region.

With such solution, the region occupied by the character information is used as the distinctive region, which facilitates users in using the map, since the character information included in the scene image is generally representative and easy to recognize and memorize by users.

Preferably, the step of extracting a distinctive region from the scene image which represents the site on the basis of a predetermined criterion comprising: retrieving images of the site from an external location; determining features of the distinctive region from the retrieved images using feature matching technology; and extracting the distinctive region from the scene image using the features.

With such solution, convenience in using the map can be improved even when no character appears in the scene image or the character cannot represent the site.

Preferably, the step of matching comprises: detecting the local features for the distinctive region and the extracted image; and matching the local feature of the distinctive region with the local feature of the extracted image to output the matching results.

With such solution, the matching results are obtained using the local feature, which avoids huge computation amount due to the matching of the entire image and thus further accelerates the map data updating process with lower requirement on device performance.

Preferably, the step of matching further comprises: calculating a metric of parallelogram for the matched local features; and correcting the matching results in case of the metric of parallelogram being less than a predetermined value.

With such solution, the match error caused by the obstruction of any obstacle upon capturing video data can be avoided, thereby leading to higher accuracy in matching operation.

According to another aspect of the present invention, a method for updating map data is provided, wherein each site on the map being associated with geographic data, at least one scene image captured at the site and a distinctive region included in the scene image, the method comprising: at each site, collecting video data and geographic data representing the position of the site; extracting from the video data at least one image which is captured at the site; matching the distinctive region and the extracted image to generate matching results; and updating the scene image using the image matched with the distinctive region as a updated image, associating the site with the distinctive region included in the updated image, and canceling the association of the site with the distinctive region included in the scene image, in case of the matching results indicating that the map data need to be updated.

With this solution, the distinctive regions representing the individual sites from the scene images of the sites on the composite map are associated, and the distinctive regions, instead of the overall scene images, are matched with images from the captured video data. Therefore, the updating of map data is accelerated with an improved accuracy for matching operation.

According to a further aspect of the present invention, a device for updating map data is provided, wherein each site on the map being associated with geographic data and at least one scene image captured at the site, the device comprising: data collecting means for, at each site, collecting video data and geographic data representing the position of the site; distinctive region association means for extracting a distinctive region from the scene image which represents the site on the basis of a predetermined criterion, and associating the distinctive region with the site; image extracting means for extracting from the video data at least one image which is captured at the site; image comparison means for matching the distinctive region and the extracted image to generate matching results; and output means for updating the scene image using the image matched with the distinctive region as a updated image, in case of the matching results indicating that the map data need to be updated.

With this solution, the distinctive regions representing the individual sites from the scene images of the sites on the composite map are associated, and the distinctive regions, instead of the overall scene images, are matched with images from the captured video data. Therefore, the updating of map data is accelerated with an improved accuracy for matching operation.

Preferably, the output means further associates the site with the distinctive region included in the updated image and cancels the association of the site with the distinctive region included in the scene image, in case of the matching results indicating that the map data need to be updated.

With the above solution, it is possible to refine the composite map in which each site is associated with both geographic data and scene image, since in the refined composite map each site is further associated with the distinctive region from the scene image. Obviously, more accurate information can be provided to users.

Preferably, the device further comprises segmenting means for segmenting the video data into video segments corresponding to streets.

With such solution, in updating map data, the update can be performed individually for each street so as to improve the manageability for the streets.

Preferably, the output means comprises: counting unit for counting the number of sites where the distinctive regions are not matched with the scene image; and updating means for updating the scene image in case of the number exceeding a predetermined threshold.

With such solution, it is possible to avoid inconvenience and resource waste due to frequent update of map data.

Preferably, the distinctive region association means comprises: localization unit for localizing character information included in the scene image by using optical character recognition technique; extracting unit for extracting the region occupied by the character information in the scene image as the distinctive region; and associating unit for associating the distinctive region and the site.

With such solution, the region occupied by the character information is used as the distinctive region, which facilitates users in using the map, since the character information included in the scene image is generally representative and easy to recognize and memorize by users.

Preferably, the distinctive region association means comprises: retrieval unit for retrieving images of the site from an external location; localization unit for determining features of the distinctive region from the retrieved images using feature matching technology; extracting unit for extracting the distinctive region from the scene image; and associating unit for associating the distinctive region and the site.

With such solution, convenience in using the map can be improved even when no character appears in the scene image or the character cannot represent the site.

Preferably, the image comparison means comprises: local feature detection unit for detecting the local features for the distinctive region and the extracted image; and matching unit for matching the local feature of the distinctive region with the local feature of the extracted image to output the matching results.

With such solution, the matching results are obtained using the local feature, which avoids huge computation amount due to the matching of the entire image and thus further accelerates the map data updating process with lower requirement on device performance.

Preferably, the image comparison means further comprises: verifying unit for calculating a metric of parallelogram for the matched local features, and correcting the matching results in case of the metric of parallelogram being less than a predetermined value.

With such solution, the match error caused by the obstruction of any obstacle upon capturing video data can be avoided, thereby leading to higher accuracy in matching operation.

According to a further aspect of the present invention, a device for updating map data is provided, wherein each site on the map being associated with geographic data, at least one scene image captured at the site and a distinctive region included in the scene image the device comprising: data collecting means for, at each site, collecting video data and geographic data representing the position of the site; image extracting means for extracting from the video data at least one image which is captured at the site; image comparison means for matching the distinctive region and the extracted image to generate matching results; and output means for updating the scene image using the image matched with the distinctive region as a updated image, associating the site with the distinctive region included in the updated image, and canceling the association of the site with the distinctive region included in the scene image, in case of the matching results indicating that the map data need to be updated.

### BRIEF DESCRIPTION OF THE DRAWINGS

The above advantages and features of the present invention will be apparent from the following detailed description taken conjunction with the drawings in which:

FIG. 1 is a schematic block diagram of a device for updating map data according to embodiments of the present invention.

FIG. 2 is a schematic diagram of the data collection part shown in FIG. 1.

FIG. 3 is schematic diagram of the data collection process by the data collection part shown in FIG. 1.

FIG. 4 is an exemplary block diagram of the distinctive region association part in the device for updating map data shown in FIG. 1.

FIG. 5 is another exemplary block diagram of the distinctive region association part in the device for updating map data shown in FIG. 1.

FIG. 6 is a detailed block diagram of the image comparison part in the device for updating map data shown in FIG. 1.

FIG. 7 is a detailed block diagram of the output part in the device for updating map data shown in FIG. 1.

FIG. 8 is a detailed flowchart of a method for updating map data according to embodiments of the present invention.

### DETAILED DESCRIPTION OF THE PREFERRED EMBODIMENTS

Hereafter, a description will be made to the preferred embodiments of the present invention with reference to the figures, throughout which like elements are denoted by like reference symbols or numbers. In the following description, the details of any known function or configuration will not be repeated, otherwise they may obscure the subject of the present invention.

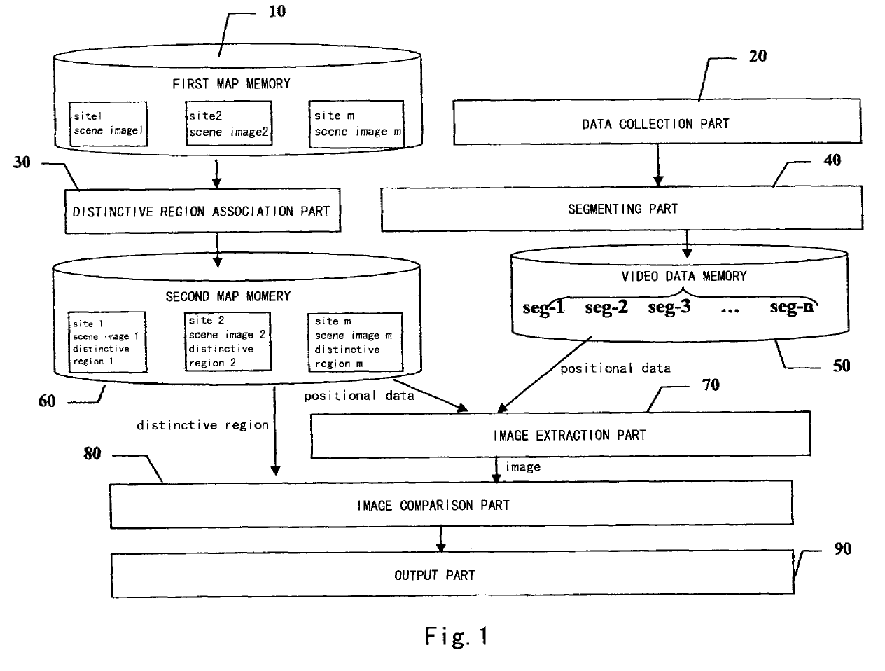

FIG. 1 is a schematic block diagram of a device for updating map data according to embodiments of the present invention. The device according to an embodiment of the present invention comprises first map memory 10, data collection part 20, distinctive region association part 30, segmentation part 40, video data memory 50, second map memory 60, image extraction part 70, image comparison part 80 and output part 90.

As shown in FIG. 1, the first map memory 10 stores a composite map formed of individual sites, such as site names, and scene images captured at these sites. Each site is associated with corresponding image, for example, site 1 associated with image 1, site 2 with image 2, site m with image m, where m is a natural number.

Although one site is associated with only one image, as shown in FIG. 1, one site can be associated with several images so that users can be provided with more specific geographic information and related facility information.

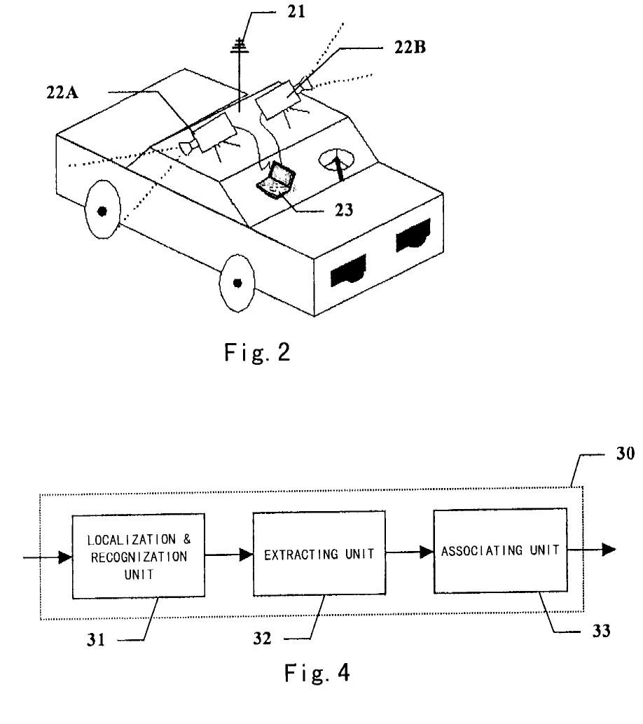

FIG. 2 shows a schematic diagram of the data collection part 20 shown in FIG. 1. Referring to FIG. 2, the data collection part 20 mounted on a vehicle comprises a positioning means 21 for collecting positional data, such as latitude and longitude as the vehicle travels and storing the positional data in a portable computer 23.

The data collection part 20 further comprises two cameras 22A and 22B for realtime collection of video images on both sides of a route as the vehicle travels along it, and the video images are stored in the portable computer 23 with correspondence to the positional data simultaneously collected by the positioning means.

In this way, as shown in FIG. 3, as the vehicle travels along the route at a predetermined speed, the positioning means 21 and the cameras 22A and 22B collect the positional data and video data at the same time, and these data are stored correspondingly in a memory (not shown) such as hard disk or CD.

When the vehicle travels from the start point and arrives at the final point along the route, the portable computer 23 stores the positional data of each site along the route and the video data captured at the site. In other words, one site is associated with multiple images.

As shown in FIG. 1, the segmentation part 40 reads out the video data for a route from the memory of the data collection part 20, segments the read video data into video segments indicated as seg-1, seg-2, . . . ,seg-n corresponding to streets, such as a street between two adjacent intersections, and stores the video segments in the video data memory 50. Here, n is a natural number.

According to another embodiment of the present invention, a finer unit, such as specific site, can be used to segment the video data into video segments seg-1, seg-2, . . . ,seg-p corresponding to these sites, and then these segments are stored in the video data memory 50. Here, p is a natural number.

As such, association is established among a street, the positional data of each site along the street and the video data captured at the site. Upon implementation of update, the map data can be updated street after street.

Referring to FIG. 1 again, the distinctive region association part 30 extracts from the scene image associated with each site a distinctive region representing the site, such as images of shop sign, company's nameplate and the like, and stores and associates the distinctive region, its position in the scene image, the scene image and the site in the second map memory 60. According to another embodiment of the present invention, the distinctive region can be any other signs, such as traffic sign. Therefore, desired signs can be extracted depending on different criteria.

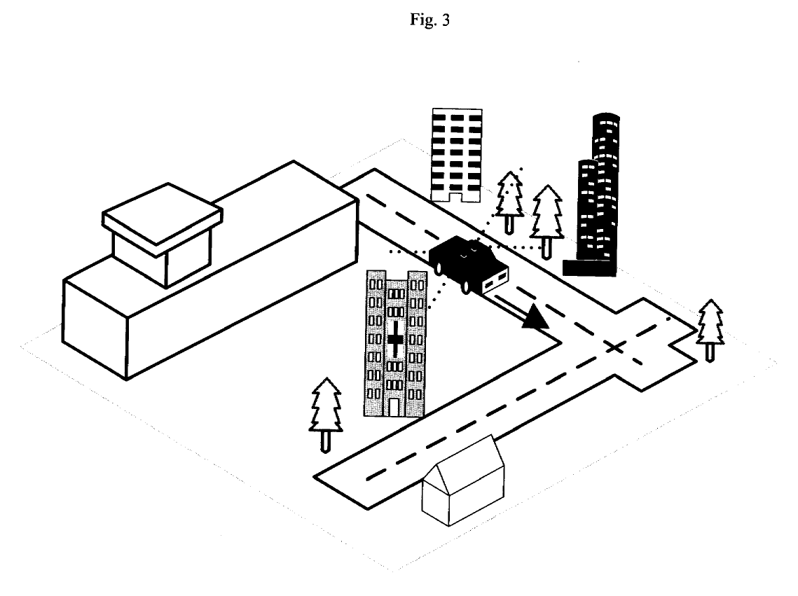

FIG. 4 is an exemplary block diagram of the distinctive region association part in the device for updating map data shown in FIG. 1. As shown in FIG. 4, the distinctive region association part 30 comprises: localization & recognition unit 31 for processing a scene image in the composite map by using optical character recognition (OCR) technique so as to localize and/or recognize character information included in the scene image; extracting unit 32 for extracting a region occupied by the character information extracted from the scene image as the distinctive region, based on the position provided by the localization & recognition unit 31; and associating unit 33 for associating the extracted distinctive region, the position of the distinctive region in the scene image, the scene image and the site.

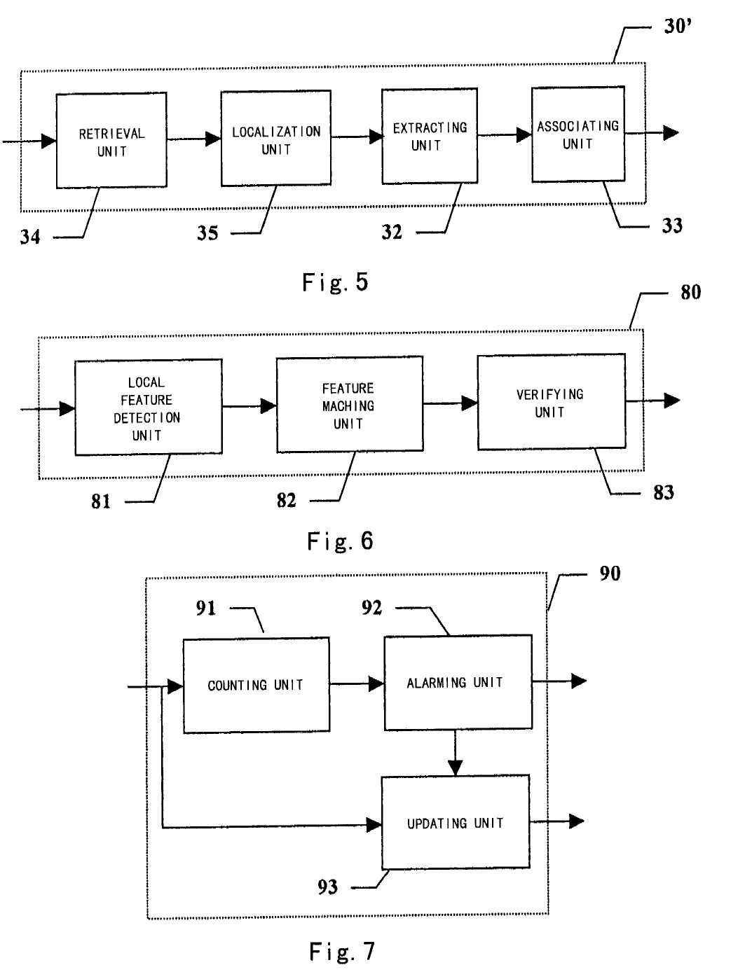

The above describes an example of using character in the scene image as the distinctive region. The present invention can also be applied to the case of no character in the scene image. FIG. 5 is another exemplary block diagram of the distinctive region association part in the device for updating map data shown in FIG. 1.

As shown in FIG. 5, the distinctive region association part 30′ comprises retrieval unit 34 for retrieving several scene images of the site from pre-established databases or Internet by using the known name of the site.

A localization unit 35 then performs feature extraction on the retrieved images to obtain texture description for these images and further finds the most consistent feature by establishing correspondence between these images. For example, part of the images containing certain feature can be matched with the other images so as to find the most consistent feature from the images.

As to the correspondence between images, given the fact that images of the same plane captured from two different view angles or points can be associated by a 8-parameter transformation, as disclosed in Non-patent document 1 (Image Mosaicing for Tele-Reality Application, Technical Report CRL-94-2, Digital Equipment Corporation Cambridge Research Lab), individual planes in the regions containing certain feature can be detected through HOUGH transformation, and the detected planes can be associated with each other. In this way, if each of the images for the same site contains a common feature, the region containing the feature will be determined as the feature region of the site.

Then, the extracting unit 32 uses the feature contained in the feature region to extract corresponding region from the scene image as the distinctive region.

Next, the associating unit 33 associates the extracted distinctive region, the position of the distinctive region in the scene image, the scene image and the site.

As shown in FIG. 1, in the composite map obtained after the distinctive region association processing, association has been established between site 1, image 1 and distinctive region 1, between site 2, image 2 and distinctive region 2 . . . , between site m, image m and distinctive region m.

Although only one distinctive region exists in one scene image, as shown in FIG. 1, several distinctive regions can be associated with the site if there are more than one distinctive region in the scene image. As such, the user can be provided with more accurate and detailed information.

The image extraction part 70, based on the positional data of each site stored in the second map memory 60, determines one video segment closest to the positional data among multiple video segments stored in the video data memory 50, and decomposes the video segment into individual images.

The image comparison part 80 reads the distinctive region of a site from the second map memory 60 and compares it with the images extracted by the image extraction part 70 sequentially to determine whether there is an image matched with the distinctive region.

FIG. 6 is a detailed block diagram of the image comparison part in the device for updating map data shown in FIG. 1. As shown in FIG. 6, the image comparison part 80 comprises local feature detection unit 81, feature matching unit 82 and verifying unit 83.

By using SIFT local feature detection algorithm recorded in Patent document 4 (U.S. Pat. No. 6,711,293) or Harris's corner detection algorithm revealed in Non-patent document 2 (C. Harris, M. Stephens, A Combined Corner and Edge Detector, Proceedings of 4^{th} Alvey Vision conference, 1998: 189-192), for example, the local feature detection unit 81 performs local feature detection on the distinctive region and the extracted images to acquire the local feature included in the distinctive region and the extracted images.

In the case of SIFT local feature detection algorithm, edge and texture features are included in so-called sub-region descriptor. The feature matching unit 82 represents the similarity between two descriptors with Euclidean distance. In addition to edge and texture features, the feature matching unit 82 can use color similarity to determine the similarity between the distinctive region and the extracted images. As an example, for the distinctive region and the extracted images, histograms of individual colors are computed, and the similarity between the distinctive region and the extracted images is represented by L1 norm between the histograms of individual colors for the distinctive region and those for the extracted images. If the similarity between the distinctive region and the extracted images exceeds a predefined similarity threshold, the feature matching unit 82 selects from the extracted images the image having the highest similarity as a candidate image for updating.

By using local feature matching instead of matching the distinctive region and the extracted images, the matching accuracy and speed can be improved at the same time.

Further, as the data collection part 20 collects image data along a street, some interference may be introduced inevitably, such as images on the sides of a bus and trees on both sides of the street. For further improving the matching accuracy, the verifying unit 83 needs to verify the selected updating image candidate. For example, the verifying unit 83 verifies the updating image candidate with a metric of parallelogram. Taking as an example one line segment having endpoints (x₁₁,y₁₁) and (x₂₁,y₂₁) and another line segment having endpoints (x₁₂,y₁₂)and (x₂₂,y₂₂), the metric of parallelogram between them is expressed as Equation (1):

$$p = \frac{( {x}_{22} - {x}_{21} ) ( {x}_{12} - {x}_{11} ) + ( {y}_{22} - {y}_{21} ) ( {y}_{12} - {y}_{11} )}{\vert ( {x}_{12} - {x}_{11} ) , ( {y}_{12} - {y}_{11} ) \vert \vert ( {x}_{22} - {x}_{21} ) , ( {y}_{22} - {y}_{21} ) \vert} + \frac{( {x}_{21} - {x}_{11} ) ( {x}_{22} - {x}_{12} ) + ( {y}_{21} - {y}_{11} ) ( {y}_{22} - {y}_{12} )}{\vert ( {x}_{21} - {x}_{11} ) , ( {y}_{21} - {y}_{11} ) \vert \vert ( {x}_{22} - {x}_{21} ) , ( {y}_{22} - {y}_{12} ) \vert} . \qquad ( 1 )$$

where |x,y|=\sqrt{x²+y²}.

If the metric of parallelogram p exceeds a predefined value, the updating image candidate is regarded as one closest to the distinctive region.

During the process of distinctive region matching, the local feature detection takes much time. In order to quicken the matching process, local features, which have been detected, can be cached in the memory for the matching of next image, since adjacent images often overlap with each other to a great extent.

By conducting the above operation on respective sites on the entire map or in a specified region, it can be determined as to whether the scene images for these sites on the map have been outdated.

FIG. 7 is a detailed block diagram of the output part in the device for updating map data shown in FIG. 1. The output part 90 comprises: counting unit 91 for counting the matching results and outputting the matching results for respective sites on the entire map or in a specified region, such as the percents of matched sites and unmatched sites in the total sites; alarming unit 92 for alerting the operator and informing that the map or the specified region needs to be updated, when the percent of unmatched sites in the total sites exceeds a predefined threshold; and updating unit 93 for replacing the scene image of the site on the original map with a verified updating image candidate, in the case that the operator confirm the need for updating.

The updating unit 93 further associates the distinctive region in the new scene image of each site with the site in the updated map while canceling the association between the site and the distinctive region in the old scene image. In this way, the site, the scene image captured at the site and the distinctive region are associated with each other in the updated map so as to provide users with the latest detailed geographic information.

The above description addresses the conventional composite map, i.e., a map in which the site is associated with only the scene image captured at the site. The present invention can also be applied to a map that has been updated according to the above process, that is, a map in which the site is associated with the scene image captured at the site and the distinctive region. In this case, the implementation differs from the above embodiment in that the operation at the distinctive region association part 30 is omitted. The rest process is the same as the above embodiment and thus not elaborated here.

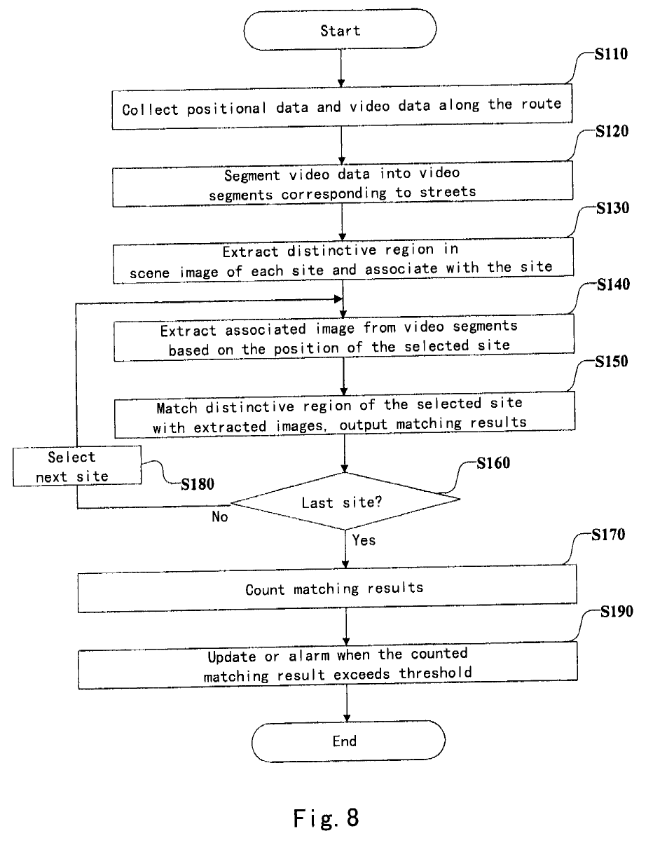

Now, the method for updating map data according to the present invention will be explained with reference to FIG. 8, which shows a detailed flowchart of a method for updating map data according to embodiments of the present invention.

At step S110, the data collection part 20 mounted on a vehicle collects positional data and video data by use of the positioning means 21 and the cameras 22A, 22B as the vehicle travels and stores the data in a memory correspondingly.

At step S120, the video data for a route is read from the memory, segmented into video segments indicated as seg-1, seg-2, . . . ,seg-n corresponding to streets, such as a street between two adjacent intersections, and stored in the video data memory 50. Here, n is a natural number.

As mentioned above, a finer unit, such as specific site, can be used to segment the video data into video segments seg-1, seg-2, . . . ,seg-p corresponding to these sites, and then these segments are stored in the video data memory 50. Here, p is a natural number.

At step S130, the distinctive region representing the site, such as images of shop sign, company's nameplate or the feature image of the site mentioned above, is extracted from the scene image associated with each site, and stores and associates the distinctive region, its position in the scene image, the scene image and the site in the second map memory 60.

As mentioned above, in the composite map obtained after the distinctive region association processing, association has been established between site 1, image 1 and distinctive region 1, between site 2, image 2 and distinctive region 2, . . . , between site m, image m and distinctive region m. Although only one distinctive region exists in one scene image, as shown in FIG. 1, several distinctive regions can be associated with the site if there are more than one distinctive region in the scene image.

At step S140, based on the positional data of each site stored in the second map memory 60, one video segment closest to the positional data among multiple video segments stored in the video data memory 50 is determined and decomposed into individual images.

At step S150, the distinctive region of one site is read from the second map memory 60 and compared with the images extracted at step S140 sequentially to determine whether there is an image matched with the distinctive region, and then the matching result is outputted.

As mentioned above, local feature detection is performed on the distinctive region and the extracted images by use of a predefined algorithm to obtain the local feature. Then, the distinctive region and the extracted images are matched on the basis of the local feature, and the image matched with the distinctive region is selected as updating image candidate. Finally, the updating image candidate is verified with a metric of parallelogram so as to output the verified matching result.

At step S160, it is determined whether the current site is the last site. If the current site is not the last one on the map or in a specified region, next site is taken from the map at step S180. The distinctive region of the site is obtained from the second map memory 60, and the processing at steps S140 and S150 is repeated on the basis of the site and the distinctive region.

If the answer is positive at step S160, that is, all of the sites on the map or in the specified region have been matched, the matching results is counted at step S170, such as the percents of matched sites and unmatched sites in the total sites.

At step S190, alarm is sent to the operator for informing that the map or the specified region needs to be updated, when the percent of unmatched sites in the total sites exceeds a predefined threshold. The scene image of the site on the original map is replaced with a verified updating image candidate, in the case that the operator confirms the need for updating. Further, the distinctive region in the new scene image of each site is associated with the site in the updated map while canceling the association between the site and the distinctive region in the old scene image.

The present invention can also be applied to a map that has been updated according to the above process, that is, a map in which the site is associated with the scene image captured at the site and the distinctive region. In this case, the implementation differs from the above embodiment in that the operation at step S130 is omitted. The rest process is the same as the above embodiment and thus not elaborated here.

Although the first map memory 10, the video data memory 50 and the second map memory 60 are described in a separate form, those skilled in the art will appreciate that these memories can also be formed as different memory areas in the same physical memory medium.

While the present invention has been described with reference to the above particular embodiments, the present invention should be defined by the appended claims other than these specific embodiments. It is obvious to those ordinarily skilled in the art that any change or modification can be made without departing from the scope and spirit of the present invention.

What is claimed is:

1. A method for updating map data, wherein each site on the map being associated with geographic data and at least one scene image captured at the site, the method comprising:
at each site, collecting video data and geographic data representing the position of the site;
extracting a distinctive region from the scene image which represents the site on the basis of a predetermined criterion, and associating the distinctive region with the site;
extracting from the video data at least one image which is captured at the site on the basis of the position of the site;
matching the distinctive region and the extracted image to generate matching results; and
updating the scene image using the image matched with the distinctive region as a updated image, in the case of the matching results indicating that the map data need to be updated.

2. The method according to claim 1, further comprising:
further associating the site with the distinctive region included in the updated image and canceling the association of the site with the distinctive region included in the scene image, in case of the matching results indicating that the map data need to be updated.

3. The method according to claim 1, further comprising:
segmenting the video data into video segments corresponding to streets.

4. The method according to claim 1, further comprising:
counting the number of sites where the distinctive regions are not matched with the scene image;
wherein the step of updating is performed in case of the number exceeding a predetermined threshold.

5. The method according to claim 1, the step of extracting a distinctive region from the scene image which represents the site on the basis of a predetermined criterion comprises:
localizing character information included in the scene image by using optical character recognition technique; and
extracting the region occupied by the character information in the scene image as the distinctive region.

6. The method according to claim 1, the step of extracting a distinctive region from the scene image which represents the site on the basis of a predetermined criterion comprising:
retrieving images of the site from an external location;
determining features of the distinctive region from the retrieved images using feature matching technology; and
extracting the distinctive region from the scene image using the features.

7. The method according to claim 1, wherein the step of matching comprises:
detecting the local features for the distinctive region and the extracted image; and
matching the local feature of the distinctive region with the local feature of the extracted image to output the matching results.

8. The method according to claim 7, wherein the step of matching further comprises:
calculating a metric of parallelogram for the matched local features; and
correcting the matching results in case of the metric of parallelogram being less than a predetermined value.

9. A method for updating map data, wherein each site on the map being associated with geographic data, at least one scene image captured at the site and a distinctive region included in the scene image, the method comprising:
at each site, collecting video data and geographic data representing the position of the site;
extracting from the video data at least one image which is captured at the site;
matching the distinctive region and the extracted image to generate matching results; and
updating the scene image using the image matched with the distinctive region as a updated image, associating the site with the distinctive region included in the updated image, and canceling the association of the site with the distinctive region included in the scene image, in case of the matching results indicating that the map data need to be updated.

10. The method according to claim 9, further comprising a step of:
segmenting the video data into video segments corresponding to streets.

11. The method according to claim 9, further comprising:
counting the number of sites where the distinctive regions are not matched with the scene image;
wherein the step of updating is performed in case of the number exceeding a predetermined threshold.

12. The method according to claim 9, wherein the step of matching comprises:
detecting the local features for the distinctive region and the extracted image; and
matching the local feature of the distinctive region with the local feature of the extracted image to output the matching results.

13. The method according to claim 12, wherein the step of matching further comprises:
calculating a metric of parallelogram for the matched local features; and
correcting the matching results in case of the metric of parallelogram is less than a predetermined value.

14. A device for updating map data, wherein each site on the map being associated with geographic data and at least one scene image captured at the site, the device comprising:
data collecting means for, at each site, collecting video data and geographic data representing the position of the site;
distinctive region association means for extracting a distinctive region from the scene image which represents the site on the basis of a predetermined criterion, and associating the distinctive region with the site;
image extracting means for extracting from the video data at least one image which is captured at the site;
image comparison means for matching the distinctive region and the extracted image to generate matching results; and
output means for updating the scene image using the image matched with the distinctive region as a updated image, in case of the matching results indicating that the map data need to be updated.

15. The device according to claim 14, wherein the output means further associates the site with the distinctive region included in the updated image and cancels the association of the site with the distinctive region included in the scene image, in case of the matching results indicating that the map data need to be updated.

16. The device according to claim 15, further comprising:
segmenting means for segmenting the video data into video segments corresponding to streets.

17. The device according to claim 14, wherein the output means comprises:
counting unit for counting the number of sites where the distinctive regions are not matched with the scene image; and
updating means for updating the scene image in case of the number exceeding a predetermined threshold.

18. The device according to claim 14, the distinctive region association means comprises:
localization unit for localizing character information included in the scene image by using optical character recognition technique;
extracting unit for extracting the region occupied by the character information in the scene image as the distinctive region; and
associating unit for associating the distinctive region and the site.

19. The device according to claim 14, the distinctive region association means comprises:
retrieval unit for retrieving images of the site from an external location;
localization unit for determining features of the distinctive region from the retrieved images using feature matching technology;
extracting unit for extracting the distinctive region from the scene image; and
associating unit for associating the distinctive region and the site.

20. The device according to claim 14, wherein the image comparison means comprises:
local feature detection unit for detecting the local features for the distinctive region and the extracted image; and
matching unit for matching the local feature of the distinctive region with the local feature of the extracted image to output the matching results.

21. The device according to claim 20, wherein the image comparison means further comprises:
verifying unit for calculating a metric of parallelogram for the matched local features, and correcting the matching results in case of the metric of parallelogram being less than a predetermined value.

22. A device for updating map data, wherein each site on the map being associated with geographic data, at least one scene image captured at the site and a distinctive region included in the scene image, the device comprising:
data collecting means for, at each site, collecting video data and geographic data representing the position of the site;
image extracting means for extracting from the video data at least one image which is captured at the site;
image comparison means for matching the distinctive region and the extracted image to generate matching results; and
output means for updating the scene image using the image matched with the distinctive region as a updated image, associating the site with the distinctive region included in the updated image, and canceling the association of the site with the distinctive region included in the scene image, in case of the matching results indicating that the map data need to be updated.

23. The device according to claim 22, further comprising:
segmenting means for segmenting the video data into video segments corresponding to streets.

24. The device according to claim 24, wherein the output means comprises:
counting unit for counting the number of sites where the distinctive regions are not matched with the scene image; and
updating means for updating the scene image in case of the number exceeding a predetermined threshold.

25. The device according to claim 22, wherein the image comparison means comprises:
local feature detection unit for detecting the local features for the distinctive region and the extracted image; and
matching unit for matching the local feature of the distinctive region with the local feature of the extracted image to output the matching results.

26. The device according to claim 25, wherein the image comparison means further comprises:
verifying unit for calculating a metric of parallelogram for the matched local features, and correcting the matching results in case of the metric of parallelogram is less than a predetermined value.
